(19) United States
(12) Patent Application Publication
(10) Pub. No.: US 2008/0167900 A1
(43) Pub. Date: Jul. 10, 2008

(54) BIOMETRIC CHARACTERIZATION OF AGENTS AND PATIENT SAFETY IN BIOLOGICAL INJECTION OR ADMINISTRATION

(75) Inventor: Arun Ranchod, Ellwood City, PA (US)

Correspondence Address: GREGORY L BRADLEY;MEDRAD INC, ONE MEDRAD DRIVE, INDIANOLA, PA, 15051, US

(73) Assignee: MEDRAD, INC., Indianola, PA (US)

(21) Appl. No.: 11/957,531

(22) Filed: Dec. 17, 2007

Related U.S. Application Data
(60) Provisional application No. 60/877,778, filed on Dec. 29, 2006.

(51) Int. Cl. G06Q 50/00

(52) U.S. Cl. 705/2

(57) ABSTRACT

A system for confirming agent compatibility with a patient to whom the agent is to be delivered includes at least one detector adapted to read stored biometric data of the patient associated with the agent and to measure biometric data of the patient, and a controller adapted to compare the stored biometric data to the measured biometric data. The controller prevents the agent from being delivered to the patient if a mismatch occurs between the stored and the measured biometric data. The agent can, for example, include autologous cells harvested from the patient.

### CROSS-REFERENCE TO RELATED APPLICATION

This application claims the benefit of U.S. Provisional Application Ser. No. 60/877,778, filed on Dec. 29, 2006, the contents of which are hereby incorporated by reference.

### BACKGROUND OF THE INVENTION

The present invention relates to biometric characterization of agents and patient safety in biological injection or other administration.

Diagnostic procedures and/or treatments that are specifically designed for use with a specific patient are being developed. In the future, many pharmaceuticals may be developed that are designed specifically for specific genotype.

Further, the treatment of disease by the injection of living cells into a body is expanding rapidly. There are many types of cells being used to treat an equally diverse set of diseases, and both types of cells and disease conditions are expanding rapidly. Xenogeneic cell therapies involve implantation of cells from one species into another. Allogeneic cell therapies involve implantation from one individual of a species into another individual of the same species. Autologous cell therapies involve implantation of cells from one individual into the same individual.

In the case of, for example, a pharmaceutical that has been developed or processed for use with an individual or in the case of autologous cell treatment, it is important to ensure that the right patient is being treated. For example, it can be quite harmful if a patient were to be injected with another person's cells. As in the case of an organ rejection, that patient's body may recognize the injected cells as foreign objects and attack them.

It is, therefore, desirable to develop devices, systems and methods for characterizing and subsequently tracking agents to be delivered to a patient to assist in maintaining patient safety in injection or other administration of such agents.

### SUMMARY OF THE INVENTION

In one aspect, the present invention provides a system for confirming agent compatibility with a patient to whom the agent is to be delivered. The agent can, for example, be a composition prepared specifically for the patient (for example, a pharmaceutical composition, and an autologous cell composition or other composition). The system comprises a detector to read biometric data of the patient associated with the agent, a sensor to measure biometric data of the patient; and a comparator to compare the read biometric data to the measured biometric data.

The biometric data associated with the agent can, for example, be attached to a container holding the agent. The comparator can, for example, include a processor.

In several embodiments, the system further includes a powered delivery system for delivering the agent. The powered delivery system can, for example, include a powered injector, an infusion pump, a syringe pump or other fluid delivery or fluid pumping system. The comparator can, for example, be in operative connection with a control system of the powered delivery system. The control system of the powered delivery system can, for example, be operative to stop (or prevent) an injection via the powered delivery system should the comparator determine that the read biometric data does not match the measured biometric data.

In another aspect, the present invention provides a container for an agent to be delivered to a patient which includes a memory associated with the container. The memory has stored therein data of at least one biometric measurement of a patient to whom the agent is to be delivered. The memory can, for example, be attached to the container. In several embodiment, the memory is part of an RFID system. The agent can, for example, include biological material harvested from the patient. For example, the agent can include cells harvested from the patient.

In another aspect, the present invention provides a method of delivering an agent to a patient, including the act of associating biometric data from the patient with the agent. The method can further include maintaining association of the biometric data with the agent during processing thereof. The biometric data can, for example, be transmitted between containers holding the agent or an intermediate of the agent during processing thereof. The method can further include creating a log of the location of the agent or an intermediate therefor over time.

The method can also include measuring biometric data from the patient before the agent is delivered to the patient; and comparing the measured biometric data to the biometric data associated with the agent. Upon determination of a mismatch between the measured biometric data and the biometric data associated with the agent, the method can include accessing the log of the location of a correct agent.

In another aspect, the present invention provides a method of delivering autologous cells, including: associating a unique identifier with autologous cells harvested from a patient, and, before delivering autologous cells to the patient, determining if the unique identifier is associated therewith. The unique identifier can include a photograph, fingerprints and/or biometric data of the patient, as described above, or a ‘smart’ label attached to the cell container. Association of the biometric data with the autologous cell can be maintained during processing thereof. The biometric data can, for example, be transmitted between containers holding the autologous cells during processing thereof.

The method can further include creating a log or record of the location of the autologous cells over time. Processing data and other information can also be recorded.

The method can further include measuring biometric data from the patient before the agent is delivered to the patient, and comparing the measured biometric data to the biometric data associated with the autologous cells.

In the case that a log is created, the method can further include accessing the log of the location of a correct agent upon determination of a mismatch between the measure biometric data and the biometric data associated with the agent.

In another aspect, the present invention provides a method of delivering an agent to a patient wherein the agent is specific to the patient, including maintaining a record of the location of the agent. The agent can, for example, include autologous cells harvested from the patient as described above. The autologous cells can, for example, be processed at a location other than the location at which the cells are harvested. The delivery of autologous cells is discussed in, for example, U.S. patent application Ser. No. 11/460,635, filed Jul. 28, 2006, PCT International Patent Application No. PCT/US06/43133 filed Nov. 6, 2006, and International Patent Application No. PCT/US06/43134 filed Nov. 6, 2006, assigned to the assignee of the present invention, the disclosures of which are incorporated herein by reference.

The present invention, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an embodiment of a system of the present invention.

FIG. 1B illustrates a flowchart for an embodiment of a process of the present invention for associating patient biometric data with an agent, measuring patient biometric data and comparing the biometric data associated with the agent to the measured biometric data.

FIG. 2 illustrates an embodiment of a cell culture bag of the present invention including patient biometric data associated therewith via memory of an RFID system.

FIG. 3 illustrates a flowchart of a process used in several studies of the present invention.

FIG. 4A illustrates an embodiment of an injector system of the present invention.

FIG. 4B illustrates an embodiment of a syringe of the present invention for use with the injector of FIG. 4A and including patient biometric data associated therewith.

FIG. 4C illustrates an embodiment of a control system of the injector of FIG. 4A.

FIG. 5A illustrates an embodiment of an infusion pump of the present invention.

FIG. 5B illustrates an embodiment of fluid bag of the present invention for use with the infusion pump of FIG. 5A and including patient biometric data associated therewith.

FIG. 6 illustrates an embodiment of a syringe pump of the present invention having a syringe attached thereto, which includes patient biometric data associated therewith.

FIG. 7 illustrates an embodiment of an agent locator or tracking log that can be made available to users.

FIG. 8 illustrates an embodiment of a system for recording and tracking log information.

### DETAILED DESCRIPTION OF THE INVENTION

In the present invention, a unique identifier such as a biometric characterization is used to associate or identify an agent with a specific patient. In general, the term “biometric” refers to an automated method of characterization for uniquely recognizing or identifying an individual based upon one or more intrinsic physical and/or behavioral characteristic. Examples of physical characteristics used in biometric methods include, but are not limited to, eye retinas and irises, fingerprints, facial patterns and hand measurements. Examples of primarily behavioral characteristics used in biometric methods include, but are not limited, gait, signature and typing patterns. An example of a characteristic used in biometric methods which is often considered to be a combination of physical and behavioral characteristics is voice. One or more biometric methods can be used in the present invention to identify or associate and agent with a specific patient.

In many cases, a patient may be partially or fully incapacitated (for example, under anesthesia) when a biometric method is to be used. In such cases, it is preferable to use a biometric method that does not require substantial patient cognizance. Fingerprinting is a widely and effectively used biometric method that can be readily used on an individual that is fully incapacitated. For these and other reasons, fingerprint technology was used as a representative example of a biometric method in several studies of the present invention. As clear to one skilled in the art, however, the devices, systems and methods of the present invention can be adapted to the use of generally any biometric method or combinations thereof.

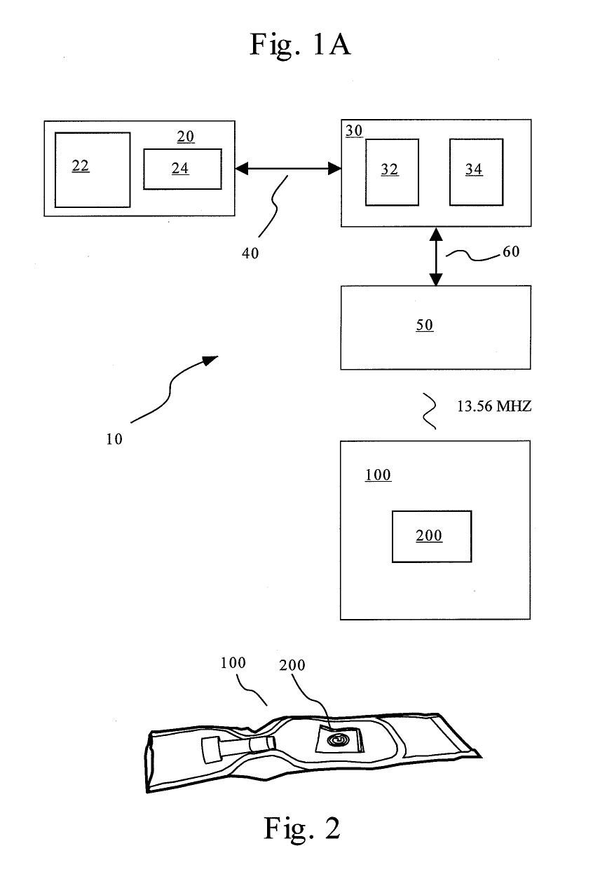

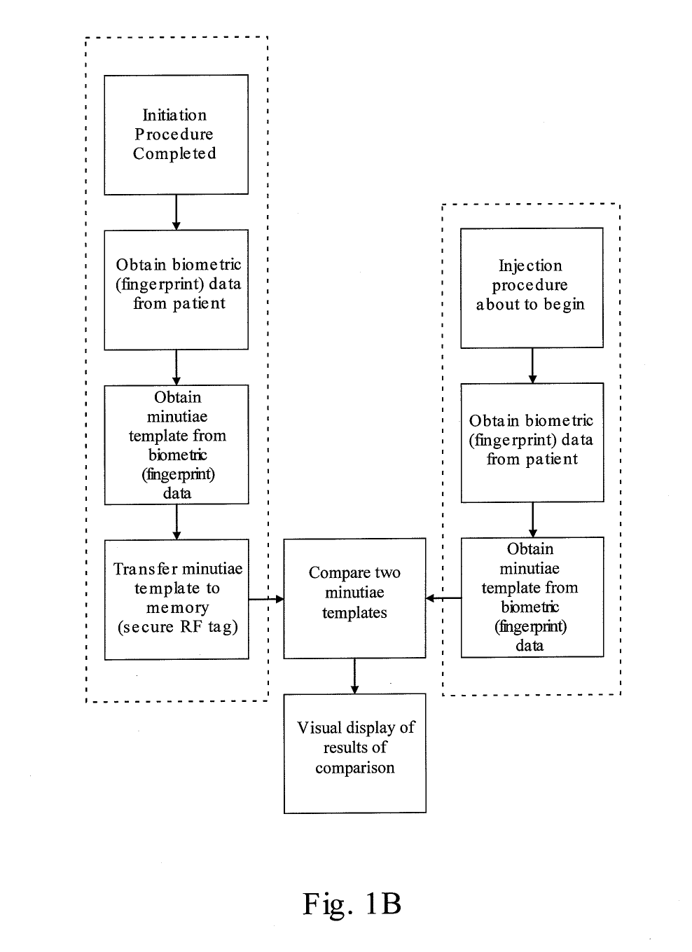

FIG. 1A illustrates an embodiment of a system 10 of the present invention. A detector 20 is provided to sense biometric data and transfer that data to a controller 30. In this embodiment, system 10 includes biometric detector 20 which includes a fingerprint sensor 22 and a processor (for example, a digital signal possessor or DSP). In a number of commercially available fingerprint systems, sensor 22 detects temperature differences according to whether the skin touches sensor 22 (corresponding to a ridge) or does not touch sensor 22 (corresponding to a valley). Sensor 22 can, for example, include a silicon die covered by a pyro-electric material. Temperature difference on the pyro-electrical layer contact can be converted to electrical charges that are subsequently amplified and measured by the underlying silicon pixels to create a black and white image. Examples of suitable fingerprint sensors for use in the present invention include, but are not limited to the AT77C101-B or ATT77C105-A FINGERCHIP® fingerprint sensors available from Atmel of San Jose, Calif.

Finger print sensor 22, as part of a printed circuit board or fingerprint daughter card, can be operatively connected to a processor such as a digital signal processor or DSP 24. An example of a suitable fingerprint sensor daughter card is the FPC1031 sensor daughter card available from Texas Instruments Incorporated of Dallas, Tex. An example of a suitable DSP for use with the FCP1031 is the TMS320C5510 Digital Signal Processor available from Texas Instruments. Recommended structure for the development and integration of drivers for the TMS320C5510 Digital Signal Processor is, for example, set forth in the DSP/BIOS Drive Developer's Guide (Literature No. SPRU616, November 2002), available from Texas Instruments, the disclosure of which is incorporated herein by reference. DSP 24 controls the function of sensor 22 and is operable to transmit data to control unit 30. Control unit 30 can, for example, include a memory 32 and a processor 34 (for example, a microprocessor). Controller 30 may be an IBM THINKPAD® running WINDOWS 2000® available from Microsoft Corporation of Redmond, Wash. DSP 24 can, for example, connect directly to controller 30 via cabling such a USB cable 40. Wireless communication, as known in the art, can also be used.

Controller 30 is in operative connection with read/write unit 50 such as the RFID S4100 Multi Function Reader (MFR) available from Texas Instruments, the operation of which is described in several Reader Series 4000 S4100 Multi-Function Reader Module reference guides available from Texas Instruments, including Base Application Protocol Reference Guide (Document No. 11-01-21-700, October 2003), Low Frequency Library Reference Guide (Document No. 11-01-21-701, October 2003), ISO 14443 Library Reference Guide (Document No. 11-01-21-702, October 2003), ISO 15693 Library Reference Guide (Document No. 11-01-21-707, October 2003), Tag-It™ Library Reference Guide (Document No. 11-01-21-708, October 2003), Download Tool Reference Guide (Document No. 11-06-24-700, October 2003), and Boot Loader Reference Guide (Document No. 11-06-24-701, October 2003), the disclosures of which is incorporated herein by reference. Further information is provided, for example, in Product Review MF Reader System Series 4000 S4100 Multi-Function Reader Module (Document No. 11-06-22-712, May 2003), Product Review MF Reader Series 4000 S4100 Multi-Function Reader Evaluation Kit (Document No. 11-06-22-719, August 2004), and S4100 Multi-function Reader Module Data Sheet (Document No. 11-06-22-715, October 2003) available from Texas Instruments, the disclosures of which are incorporated herein by reference. Unit 50 enables writing of data to a data storage device that is placed in association or operative connection with a storage/transport container for the agent as well as subsequent reading of such data as described further below. As clear to those skilled in the art, such read/write functions can be divided into a separate read unit and a separate write unit. The S4100 MFR allows users to, among other functions, execute standard read/write/lock commands and supports 134.2 and 13.56 MHz wireless transmission. In the present invention, 13.56 MHz transmissions are preferred. Read/write unit 50 is placed in communicative connection with controller 30 via a standard serial cable 60. As clear to those skilled in the art, communication between read/write unit 50 and controller 30 can alternatively be effected via wireless transmission.

FIG. 1B illustrates a flow chart of one mode or embodiment of operation of a system of the present invention such as system 10 illustrated in FIG. 1A. In general, biometric data is first stored in a memory or data storage system associated with the agent to be delivered to the patient. The acts involved in that process are set forth in the dashed area on the left side of FIG. 1B. For example, a system initiation procedure is first completed. A biometric characterization is then obtained from the patient. In the embodiment of system 10, a fingerprint is taken from the patient by contacting one of the patient's finger with sensor 22.

From the biometric data measured, key features can, for example, be extracted and stored in a portable electronic format in memory 32, thereby constituting an electronic “signature” for the donor/patient. In the case of fingerprint biometrics, minutiae extraction can be implemented with products such as BIOENGINE® Software Developer's Kit available from Intentix Inc. of Minnetonka, Minn. The BIOENGINE Software Developer's Kin includes fingerprint matching and recognition capabilities that allow developers to create custom one-to-one verification and one-to-many identification applications. Such a minutiae-based file or template is typically no more than approximately 500 bytes in size.

The minutiae-based template can then be transferred to, for example, a secure memory such as EEPROM that is, for example, affixed to the container used to collect, store, process and/or deliver the agent. This transfer could be accomplished either wirelessly or in a connected state. A suitable EEPROM for use in the present invention is the SLE66 CL 80P EEPROM, available from Infineon Technologies of San Jose, Calif. Many other options are also available. The memory or storage device can also have capability to transfer the data to other, like devices for subsequent transfer of patient data and patient biometric signature.

Many pharmaceuticals agents and/or biological agents are transferred to, for example, laboratories or other facilities for storage and/or processing prior to injection into the patient. In the case of autologous cells, such processing steps can, for example, include sample centrifuge, cell “washing”, buffer replacement and/or cell culturing to generate more cells. During this process, it is desirable that any containers used to house the agent travel with the collected patient data. The goal is to always have the agent and the information together or associated. This goal can be achieved by having the various containers equipped with secure memory (for example, EEPROM) devices capable of receiving and sending information. Again, this transfer of information can be accomplished either by proximity (wireless) or connected transfer.

Fingerprint biometric data may be taken from a patient as described above. The data is then transferred to an RFID tag 200 attached to a cell culture bag 100. An example of a suitable RFID tag is the RI-I16-112A Transponder (RF Tag) available from Texas Instruments. RFID tag 200 is affixed to a VUELIFE™ cell culture bag (see FIGS. 1A and 2) available, for example, from American Fluoroseal Corporation of Gaithersburg, Md. Such cell culture bags are, for example, often used in the collection and processing of autologous stem cells from patients.

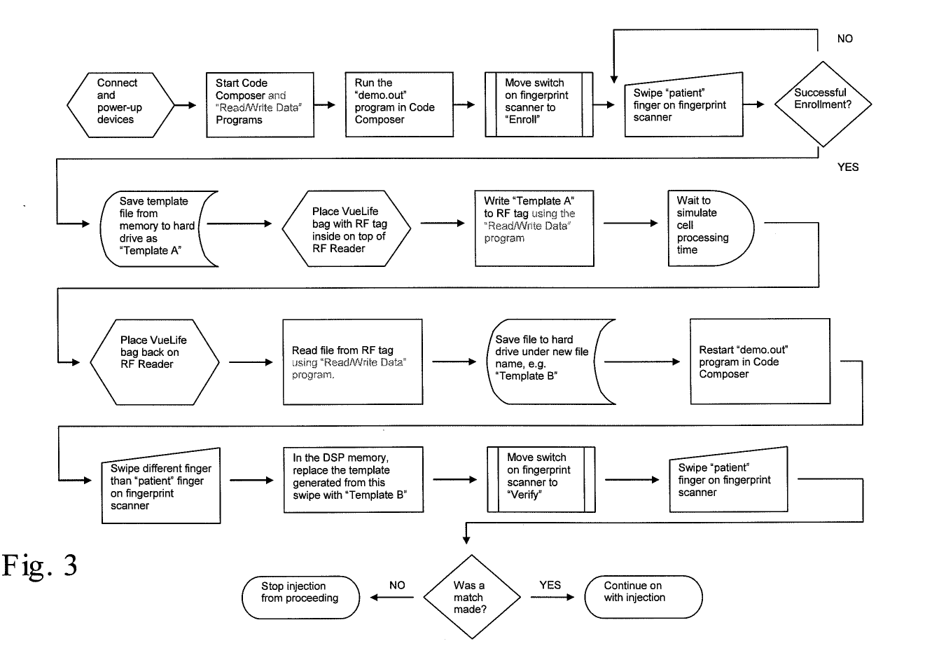

In the dashed area on the right side of FIG. 1B the series of acts that occur at the time the agent it so be injected or otherwise delivered to the patient are set forth. A goal of these series of acts is to match donor/patient biometric measured at the time of delivery with the stored biometric “signature” associated with the agent. At the time of injection, the patient's biometric information is presented to the device by the patient or medical personnel (e.g., the patient's finger is placed on a fingerprint apparatus or sensor such as sensor 22). The apparatus mirrors the steps described above and obtains a fingerprint (and/or other biometric data), performs a feature extraction and stores an electronic copy of, for example, a minutiae-based template as describe above. This template is then compared with the previously obtained patient template that is present on the memory (for example, RFID tag 200 or other memory), received from, for example, a laboratory. The two templates are, for example, compared by controller 30 and/or other comparator. If the two respective templates are deemed a match, then the user can, for example, be presented with positive feedback indicating that the agent received from the laboratory is, in fact, derived from or otherwise prepared for the patient who submitted the fingerprint. FIG. 3 illustrates a process flowchart of the acts or steps taken in a number of studies of the present invention

If the two templates are not a match, the user can, for example, be presented with feedback indicating that the agent received from the laboratory is not derived from or otherwise prepared for the patient who submitted the fingerprint. This feedback can, for example, be presented on a stand-alone device such as display in operative connection with controller 30 in, for example, the form of a laptop or other computer that provides the processing means for the template comparison.

In the case that a delivery mechanism or device is used to delivery an agent, controller 30 can, for example, be part of the control system of the delivery device or in communicative connection therewith so that, for example, a template mismatch can be presented as an alarm or other indication and/or an inability to complete an injection or other delivery. The comparator can be incorporated as a feedback mechanism on the delivery device. Examples of delivery devices in connection with which the devices, systems and methods of the present invention can be use include, but are not limited to, pressuring devices such as powered injectors (for example, syringe-based powered injectors), infusion pumps, syringe pumps and other pumps.

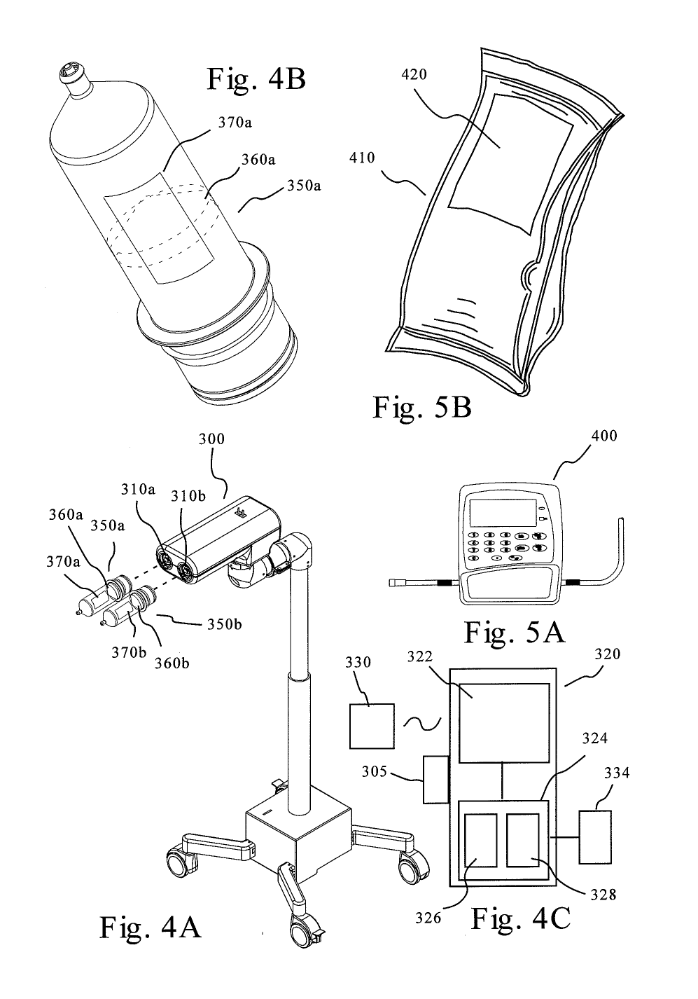

FIG. 4A illustrates an example of a powered injector 300 such as the STELLANT® injector, available from Medrad, Inc. of Indianola, Pa. Aspects of various syringes and injectors suitable for use in the present invention are described, for example, in U.S. Pat. Nos. 6,643,537, 6,562,008 and 6,652,489 and U.S. Published Patent Application No. 2004-0064041, the disclosures of which are incorporated herein by reference. Injector 300 includes drive members 310a and 310b that are operable to control the positions of plungers 360a and 360b of syringe 350a and 350b, respectively. One or both of syringes 350a and 350b can include a memory system such as an RFID tag 370a and 370b, respectively, as described above for storing biometric data and transmitting biometric data as described above. FIG. 4B illustrates an enlarged view of syringe 370a.

As illustrated in FIG. 4C, injector 300 can, for example, include a control system 320 as known in the art. Control system 320 can include a reader or detector 322 in connection with a controller 324 including a memory 326 and processor 328 (for example, a microprocessor). Prior to an injection, one or more biometric measurements (for example, a fingerprint) is taken from the patient as described above. A transmitter 330 transmits the data to a reader 322, which provided the data to controller 324. The biometric data from tags 370a and 370b are also read and transmitted to reader 322. (The reader 322 can reside on the container or the injector 300, or be a stand alone device.) Processor 328 compares the biometric data from the patient and from tags 370a and 370b to determine if there is a match. If a match is determined, the injection procedure can proceed. If a mismatch is determined, an operator can be informed via, for example, a display 334. Further, determination of a mismatch can cause injector 300 to disarm and/or otherwise prevent injection.

FIG. 5A illustrates an embodiment of an infusion pump 400 that can, for example, include a control system similar to control system 320. Infusion pump 400 can, for example, operate in connection with a fluid bag 410 as illustrated in FIG. 5B, which can include biometric data in a memory of, for example, an RFID tag 420.

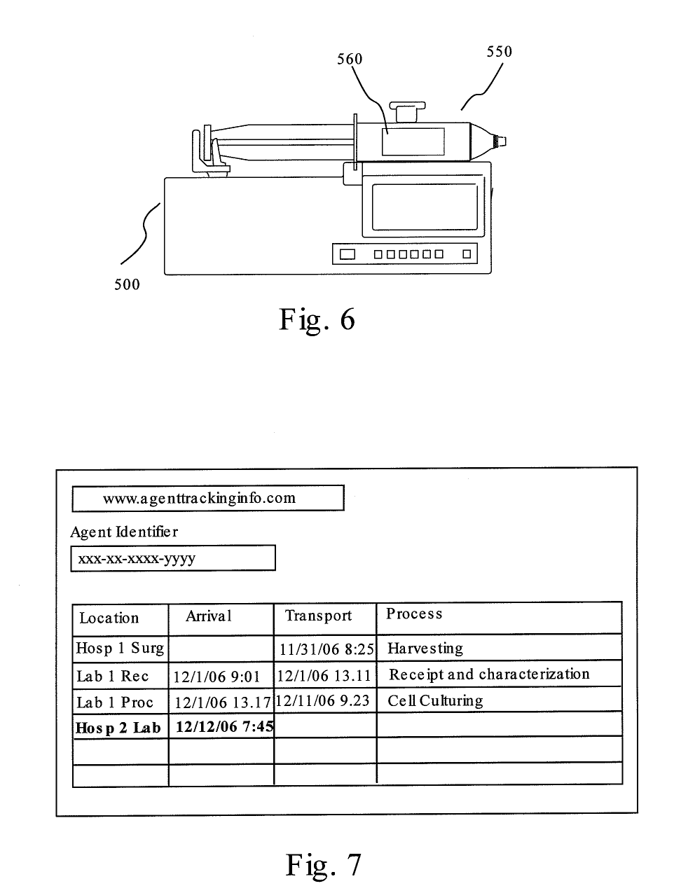

FIG. 6 illustrates an embodiment of a syringe pump 500 that can, for example, include a control system similar to control system 320. Syringe pump 500 can, for example, be adapted to pressurize the contents of syringe 550, which can include biometric data in memory of, for example, an RFID tag 560.

The devices, systems and methods of the present invention can, for example, be used in connection with the information system and labels disclosed in U.S. patent application Ser. No. 11/530,045, filed Sep. 8, 2006, assigned to the assignee of the present invention, the disclosure of which is incorporated herein by reference, a copy of which is provided herewith and made a part hereof. U.S. patent application Ser. No. 11/530,045, discloses stand-alone intelligent package system for medical, pharmaceutical or hazardous material applications, including at least one integral active display. Tags or labels such as tags 370a and 370b of the present invention can, for example, include information in addition to biometric data. For example, composition, processing history, and/or other information such as location history information as described below can be included in memory thereof. Moreover, tags 370a and 370b can include a display such as the static and active displays discussed in U.S. patent application Ser. No. 11/530,045, which use, for example, Polymer LED and Organic LED technologies.

In the case, for example, that a mismatch is determined upon comparison of the patient biometric data and comparison to the patient biometric data stored in association with the agent, a tracking process can be initialized to locate the correct agent. As discussed above, it is desirable that any containers used to house the agent travel with the collected patient data so that the biometric information is always associated with the agent. Further, information associated with the agent can also be scanned/read at each location or processing step. For example, a log can be kept including the time of arrival at a location, the time of transport from a location and a description of the processing steps taken. An example of such a log is set forth in FIG. 7. This log is similar to the tracking service provided, for example, by various package delivery services such as the Unites States Postal Service, by United Parcel Service of America, Inc. or by FedEx. Similar to those services, upon a determination of a mismatch by a comparator in the present invention, an operator can log onto, for example, a secure internet web site (www.agenttrackinginfo.com in FIG. 7) to access a database of agent location and thereby track the location of the correct agent. The patient biometric data itself can be used to identify the agent for this tracking process. Moreover, in addition to patient biometric data, another unique agent identifier such as a unique alphanumeric identifier (which can, for example, be based upon a patient's social security number) can be associated with the agent (for example, stored in memory). By entering the agent identifier and/or uploading the biometric data, an agent log is accessed as illustrated in FIG. 7.

Upon determination of a mismatch, a system of the present invention can prompt an operator or user to search the agent log database. For example, an injector such as injector 300 can include a display upon which the user is prompted as described above. Injector 300 or other fluid delivery system can also include a suitable communication system 305 (see FIG. 4C) in operative connection therewith to connect to the database and provided the location and other information to the user. Such a communication system can, for example, include a suitable wired or wireless interface to a network such as the internet. Alternatively, it can simply be part of the standard protocol to log onto the database in the case of a mismatch.

Location data can, for example, be logged at each location processing step using RFID technology as described above. Other wireless and/or wired data transmission and storing processes as known in the art can also or alternatively be used.

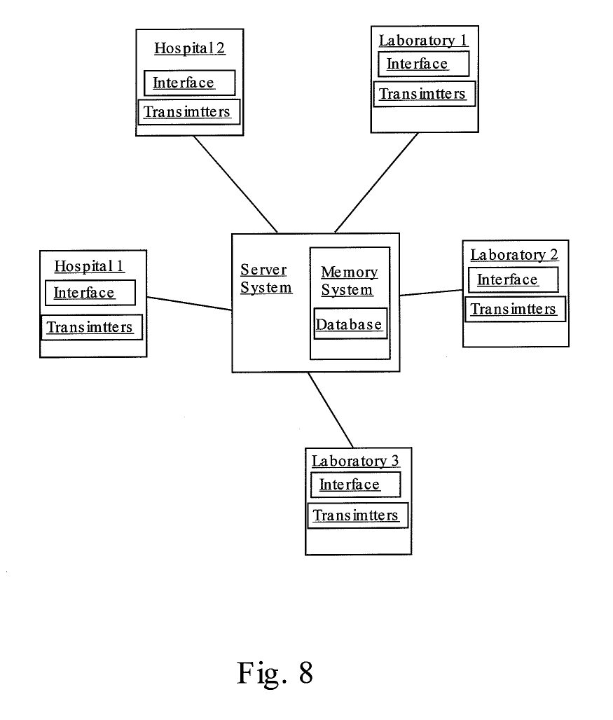

FIG. 8 illustrates an embodiment of a system of the present invention for logging location and other information of agents such a autologous cells from harvesting, through processing and delivery to a final destination for delivery to a patient. Each of the locations can include one or more interface to read/write data from/to, for example, the memory system associated with the autologous cells. Likewise, each of the locations can include one or more transmitters to transmit location and other information to a server system (which can be centralized or distributed) so that a database of the information can be maintained on an associated memory system. In that regard, the cells can, for example, be harvested in a surgical room of Hospital 1. This information is transmitted to the server system for logging in the database (see FIG. 7). The cells can then be transmitted to a first laboratory (Laboratory 1) at which the cells are characterized. This information is transmitted to the server system for logging in the database (see FIG. 7). The cells can then be transmitted to a second laboratory (Laboratory 2) at which the cells are cultured. This information is transmitted to the server system for logging in the database (see FIG. 7).

In the embodiment of FIG. 7, although the cells should then have been transferred back to Hospital 1 for delivery of the patient, the cells were mistakenly transferred to Hospital 2. This information is also transmitted to the server system for logging in the database (see FIG. 7). If Hospital 1 does not receive the cells in a timely manner or receives the wrong cells (resulting in a mismatch as described above). The personnel of Hospital 1 can readily access the database to determine the location of the correct cells.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A system for confirming agent compatibility with a patient to whom the agent is to be delivered, the system comprising:
a container for holding the agent;
a memory device associated with the container, the memory device including stored biometric data of the patient;
at least one detector adapted to read the stored biometric data associated with the container and to measure biometric data from the patient;
a delivery system associated with the container and comprising a controller in communication with the at least one detector, the controller adapted to compare the stored biometric data to the measured biometric data to confirm the compatibility of the agent to the patient and to prevent delivery of the agent to the patient should the controller determine that the stored biometric data does not match the measured biometric data.

2. The system of claim 1 wherein the memory device is an EEPROM or an RFID tag.

3. The system of claim 1 wherein the container is a syringe or a bag.

4. The system of claim 1 wherein the at least one detector comprises two detectors, a first detector adapted to read the stored biometric data associated with the container and a second detector adapted to measure biometric data from the patient.

5. The system of claim 1 wherein the delivery system is an injector, a syringe pump or an infusion pump.

6. A method of delivering an agent to a patient, comprising:
associating biometric data from the patient with the agent;
measuring biometric data from the patient before the agent is delivered to the patient;
comparing the measured biometric data to the biometric data associated with the agent; and
upon determination of a mismatch between the measured biometric data and the biometric data associated with the agent, preventing the agent from being delivered to the patient.

7. The method of claim 6, further comprising:
maintaining association of the biometric data with the agent during processing thereof.

8. The method of claim 7 wherein the biometric data is transmitted between containers holding the agent or an intermediate of the agent during processing thereof.

9. The method of claim 6, further comprising:
creating a log of the location of the agent or an intermediate therefor over time.

10. The method of claim 9, further comprising:
upon determination of a mismatch between the measured biometric data and the biometric data associated with the agent, accessing the log of the location of a correct agent.

11. A method of delivering autologous cells, comprising:
associating a unique identifier with autologous cells harvested from a patient; and
before delivering autologous cells to the patient, determining if the unique identifier is associated therewith.

12. The method of claim 11 wherein the unique identifier comprises biometric data of the patient.

13. The method of claim 12, further comprising,
maintaining association of the biometric data with the autologous cells during processing thereof.

14. The method of claim 13 wherein the biometric data is transmitted between containers holding the autologous cells during processing thereof.

15. The method of claim 12, further comprising:
measuring biometric data from the patient before the autologous cells are delivered to the patient;
comparing the measured biometric data to the biometric data associated with the autologous cells; and
preventing the delivery of the autologous cells if there is a mismatch between the measured biometric data and the biometric data associated with the autologous cells.

16. The method of claim 15, further comprising:
creating a log of the location of the autologous cells over time.

17. The method of claim 16, further comprising:
upon determination of a mismatch between the measured biometric data and the biometric data associated with the autologous cells, accessing the log of the location of a correct autologous cells.

18. The method of claim 6, further comprising:
maintaining a record of the location of the agent.

19. The method of claim 18 wherein the agent comprises autologous cells harvested from the patient.

20. The method of claim 19 wherein the autologous cells are processed at a location other than the location at which the cells are harvested.
